(19) United States
(12) Patent Application Publication
(10) Pub. No.: US 2013/0230765 A1
(43) Pub. Date: Sep. 5, 2013

(54) CURRENT COLLECTOR COPPER FOIL OF NEGATIVE ELECTRODE FOR LITHIUM ION SECONDARY BATTERY, METHOD OF MANUFACTUING THE CURRENT COLLECTOR COPPER FOIL OF NEGATIVE ELECTRODE FOR LITHIUM ION SECONDARY BATTERY, NEGATIVE ELECTRODE FOR LITHIUM ION SECONDARY BATTERY, METHOD OF MANUFACTURING NEGATIVE ELECTRODE FOR LITHIUM ION SECONDARY BATTERY, AND LITHIUM ION SECONDARY BATTERY

(71) Applicant: HITACHI CABLE, LTD., Tokyo (JP)

(72) Inventors: Yoshiki SAWAI, Tokyo (JP); Satoshi SEKI, Tokyo (JP)

(73) Assignee: HITACHI CABLE, LTD., Tokyo (JP)

(21) Appl. No.: 13/728,090

(22) Filed: Dec. 27, 2012

(30) Foreign Application Priority Data
Mar. 1, 2012 (JP) 2012-045629

(51) Int. Cl. H01M 4/66; H01M 4/04

(52) U.S. Cl. CPC H01M 4/662; H01M 4/0402
USPC 429/178; 429/211; 148/432; 148/685; 29/825

(57) ABSTRACT

There is provided a current collector copper foil of negative electrode for lithium ion secondary battery, including: at least 0.15 wt % or more and 0.40 wt % or less of Cr; and Cu as a remaining portion, wherein a Cr solid solution index Z is in a range of 0.05≦Z≦0.3 and represented by the following formula: Z=(R_{M}−R_{S})/(R_{P}−R_{S}) . . . (1), wherein R_{M} indicates an actually measured conductivity R (% IACS) of a negative battery current collector copper foil, and R_{S} indicates a calculated value (% IACS) of conductivity R of the negative electrode current collector copper foil 10 in a case that a total content of Cr is solid-soluted, and conductivity R_{P} indicates a calculated conductivity R (% IACS) of the negative electrode current collector copper foil 10 in a case that the total content of Cr is separated.

### BACKGROUND

1. Technical Field

The present invention relates to a current collector copper foil of negative electrode for lithium ion secondary battery, a method of manufacturing the same, a negative battery including the current collector copper foil of negative electrode for lithium ion secondary battery, and a method of manufacturing the same, and a lithium ion secondary battery.

2. Description of Related Art

With a progress of thin and small electronic devices, a secondary battery with high energy density is desired as a power source of the electronic devices. A secondary battery is a battery of extracting a chemical energy of a positive electrode active material and a negative battery active material, to outside as an electric energy, by a chemical reaction through the intermediary of an electrolyte. A lithium ion secondary battery can be given as the secondary battery in practical use, which has a high energy density.

The lithium ion secondary battery is constituted of a positive electrode, a negative battery, a separator for insulating the positive electrode from the negative electrode, and an electrolyte enabling lithium ions to move between the positive electrode and the negative electrode. By movement of the lithium ions between the positive electrode active material and the negative electrode active material (intercalation, deintercalation), discharge and charge are repeated.

A carbon material having a multilayer structure capable of inserting the lithium ions into inter-layers and discharging the lithium ions from the inter-layers, is mainly used as the negative electrode active material used for the lithium ion secondary battery. Further, in recent years, further higher capacity is requested for the lithium ion secondary battery. Therefore, development of the negative electrode active material of the next generation having a discharge/charge capacity considerably exceeding a theoretical capacity of the carbon material, namely the development of a high capacity negative electrode active material, has been in progress in recent years. More specifically, materials containing metal such as silicon (Si) and tin (Sn) capable of being alloyed with lithium (Li) are expected.

A general method of manufacturing the negative electrode for lithium ion secondary battery is as follows. Namely, slurry is obtained by dispersing the negative electrode active materials in a solution together with a binder resin component and conductive materials, and both sides of a negative battery current collector copper foil being a negative battery current collector, are coated with such a slurry. Thereafter, the solution is dried and removed to form a negative battery mixture layer (negative electrode active material), which is then subjected to compressive molding by a roll pressing machine, to thereby manufacture the negative electrode for lithium ion secondary battery. When Si and Sn, etc., are used for the negative electrode active material, volume variation of these materials is great when storing and releasing the lithium ions during charge/discharge thereof. Therefore, active particles are peeled-off and fell-off from the negative electrode current collector copper foil by repeating expansion and contraction in a process of discharging/charging cycles. Therefore, deterioration in the process of cycles (cycle deterioration) easily occurs.

Accordingly, for example patent documents 1 to 3 disclose a technique of using a thermoplastic binder resin such as polyimide having a high binding performance. Namely, when manufacturing the negative electrode for lithium ion secondary battery, heat treatment is performed at a temperature higher than a temperature of a thermoplastic region of the binder resin. Thus, a large quantity of binder resin enters into roughened surfaces of the active particles such as Si and Sn, to thereby improve the binding performance. As the binding performance is improved, destruction of a current collecting structure in the negative electrode for lithium ion secondary battery can be suppressed, and a discharge/charge cycle performance can be improved.

### PATENT DOCUMENTS

### Patent Document 1

Japanese Patent Laid Open Publication No. 2006-278123

### Patent Document 2

Japanese Patent Laid Open Publication No. 2006-278124

### Patent Document 3

International Publication No. 2007/114168 pamphlet

Here, in order to obtain a high binding performance in the binder resin having a high binding performance such as a thermoplastic binder resin like polyimide, heat treatment at a high temperature is required. When using the polyimide, the heat treatment is required to be performed at a temperature of 150° C. or more where imidization starts to occur, and at a temperature of 500° C. or less where polyimide is not completely decomposed. However, at a low temperature of about 150° C., a long time heat treatment is required for obtaining a sufficient imidization, thereby involving a problem of low productivity. Therefore, the heat treatment at 350° C. to 500° C. is preferable.

However, when the heat treatment is performed at such a high temperature, softening occurs in the negative electrode current collector copper foil coated with slurry, thus remarkably reducing a mechanical strength, resulting in causing a deformation of the negative electrode current collector copper foil in a process of a volume variation of the negative electrode active material by a discharge/charge performance, thereby deteriorating a discharge/charge cycle performance.

Meanwhile, in order to have an extremely high mechanical strength before applying the heat treatment, to maintain a sufficient mechanical strength of the negative electrode current collector copper foil even after the softening of the negative electrode current collector copper foil due to the heat treatment, there is a necessity for increasing an alloy component for example. Then, due to increase of the alloy component, conductivity of the negative electrode current collector copper foil is reduced. Further, a rolling step during manufacture requires a high cost, thus involving a difficulty that the negative electrode current collector copper foil becomes expensive. Such a reduction of the conductivity of the negative electrode current collector copper foil becomes one of the factors of increasing an internal resistance of the lithium ion secondary battery and deteriorating a discharge rate performance, etc. Moreover, such an expensive negative electrode current collector copper foil is directly linked to a higher cost of the lithium ion secondary battery, thus possibly preventing a general spread of equipment using the lithium ion secondary battery.

### SUMMARY OF THE INVENTION

An object of the present invention is to provide a current collector copper foil of negative electrode for lithium ion secondary battery capable of maintaining a sufficient mechanical strength even after undergoing a heat treatment in a manufacturing step of a negative electrode for lithium ion secondary battery, and a method of manufacturing the same, and a negative battery including the current collector copper foil of negative electrode for lithium ion secondary battery, and a method of manufacturing the same, and a lithium ion secondary battery.

According to a first aspect of the present invention, there is provided a current collector copper foil of negative electrode for lithium ion secondary battery, including:

at least 0.15 wt % or more and 0.40 wt % or less of Cr; and

Cu as a remaining portion,

wherein a Cr solid solution index Z is in a range of 0.05≦Z≦0.3 and represented by the following formula (1),

$$\begin{matrix}[ Formula 1 ] & \\ Z = \frac{( {R}_{M} - {R}_{S} )}{( {R}_{P} - {R}_{S} )} & ( 1 )\end{matrix}$$

wherein in the formula (1), conductivity R_{M} indicates an actually measured conductivity R (% IACS) of the current collector copper foil of negative electrode for lithium ion secondary battery, and conductivity R_{S} indicates a calculated conductivity R (% IACS) of the current collector copper foil of negative electrode for lithium ion secondary battery, which is the conductivity R (% IACS) defined by the following formula (3) from electric resistivity ρ obtained by substituting a content concentration [atomic %] of each alloy element in a solid-soluted state when a total content of the Cr is solid-soluted, into the following formula (2), and conductivity R_{P} indicates a calculated conductivity R (% IACS) of the lithium ion secondary negative electrode current collector copper foil, which is the conductivity R (% IACS) defined by the following formula (3) from electric resistivity ρ obtained by substituting a content concentration [atomic %] (at %) of each alloy element in a solid-soluted state when a total content of the Cr is separated, into the following formula (2),

$$\begin{matrix} [ Formula 2 ] & \\ ρ = 17.241 + ( 40 \times Cr concentration [ at \% ] + 1.2 \times Ag concentration [ at \% ] + 28.8 \times Sn concentration [ at \% ] + 10.5 \times In concentration [ at \% ] + 116.1 \times Ti concentration [ at \% ] + 110 \times Zr concentration [ at \% ] ) - ( 3.2 \times 28.8 \times Sn {concentration [ at \% ]}^{2} + 2.4 \times 10.5 \times In {concentration [ at \% ]}^{2} + 116.1 \times Ti {concentration [ at \% ]}^{2} ) / 100 & ( 2 ) \\ [ Formula 3 ] & \\ R = ( \frac{17.241}{ρ} ) \times 100 & ( 3 )\end{matrix}$$

According to a second aspect of the present invention, there is provided the current collector copper foil of negative electrode for lithium ion secondary battery of the first aspect, containing 0.01 wt % or more and 0.40 wt % or less of one kind or more elements in total, selected from a group consisting of Ag, Sn, In, Ti, and Zr.

According to a third aspect of the present invention, there is provided the current collector copper foil of negative electrode for lithium ion secondary battery of the first aspect, having a thickness of 20 μm or less.

According to a fourth aspect of the present invention, there is provided a method of manufacturing a current collector copper foil of negative electrode for lithium ion secondary battery, including:

applying hot-rolling to a copper alloy material containing at least 0.15 wt % or more and 0.40 wt % or less of Cr to form a plate material;

applying cold-rolling to the plate material to form a base material;

applying solid solution treatment to the base material, with a temperature of the base material maintained to 850° C. or more and 950° C. or less; and
applying final cold-rolling to the base material that has undergone the solid solution treatment.

According to a fifth aspect of the present invention, there is provided the method of manufacturing a current collector copper foil of negative electrode for lithium ion secondary battery of the fourth aspect, wherein the copper alloy material contains 0.01 wt % or more and 0.40 wt % or less of one kind or more elements in total, selected from a group consisting of Ag, Sn, In, Ti, and Zr.

According to a sixth aspect of the present invention, there is provided the method of manufacturing a current collector copper foil of negative electrode for lithium ion secondary battery of the fourth aspect, wherein in applying the final cold-rolling, cold-rolling is applied to the base material so that a degree of cold-rolling is 95% or more and 99% or less, and a thickness of the base material is set to 20 μm or less.

According to a seventh aspect of the present invention, there is provide the method of manufacturing a current collector copper foil of negative electrode for lithium ion secondary battery of the fourth aspect, wherein after an end of applying the base material solid solution treatment, the temperature of the base material is maintained to less than 350° C. until application of the final cold-rolling is ended.

According to an eighth aspect of the present invention, there is provided a negative electrode for lithium ion secondary battery, including:

the current collector copper foil of negative electrode for lithium ion secondary battery of the first aspect;

a negative battery active material layer formed at least one side of the current collector copper foil of negative electrode for lithium ion secondary battery; and

a tab lead connected to the lithium ion secondary negative electrode current collector copper foil.

According to a ninth aspect of the present invention, there is provided a method of manufacturing a negative electrode for lithium ion secondary battery, including:

coating at least one side of a current collector copper foil of negative electrode for lithium ion secondary battery manufactured by the method of the fourth aspect, with slurry in which a negative battery active material and a binder solution are kneaded;

applying heat treatment to the current collector copper foil of negative electrode for lithium ion secondary battery which is coated with the slurry, to solidify a binder component in the slurry, and forming a negative battery active material layer on at least one side of the lithium ion secondary negative electrode current collector copper foil; and

connecting a tab lead to the lithium ion secondary negative electrode current collector copper foil,

wherein in applying the heat treatment, heat treatment is applied for 1 hour or more and 15 hours or less, with a temperature set to 350° C. or more and 500° C. or less.

According to a tenth aspect of the present invention, there is provided a lithium ion secondary battery, including:

the negative electrode for lithium ion secondary battery of the eight aspect;

a lithium ion secondary battery positive electrode;

a separator inserted between the negative electrode for lithium ion secondary battery and the lithium ion secondary battery positive electrode; and

a container in which the negative electrode for lithium ion secondary battery and the lithium ion secondary battery positive electrode are housed, with the separator inserted between them, and an electrolyte is enclosed therein.

According to the present invention, there are provided the current collector copper foil of negative electrode for lithium ion secondary battery, and the method of manufacturing the same, and the negative electrode including the current collector copper foil of negative electrode for lithium ion secondary battery, and the method of manufacturing the same, and the lithium ion secondary battery, capable of maintaining a sufficient mechanical strength even after undergoing the heat treatment in the manufacturing step of the negative electrode for lithium ion secondary battery.

### BRIEF DESCRIPTION OF THE DRAWINGS

FIG. 1 is a flowchart showing manufacturing steps of a current collector copper foil of negative electrode for lithium ion secondary battery according to an embodiment of the present invention.

FIG. 2 is a plane view of a negative electrode for lithium ion secondary battery according to an embodiment of the present invention.

FIG. 3 is a perspective cross-sectional view of a lithium ion secondary battery according to an embodiment of the present invention.

### DETAILED DESCRIPTION OF THE INVENTION

### Knowledge Obtained by Inventors of the Present Invention

For example, a copper-chromium (Cu—Cr) alloy rolled copper foil, etc., is used for the aforementioned current collector copper foil of negative electrode for lithium ion secondary battery. Cr is solid-soluted into Cu being a parent phase, to thereby improve a heat resistant property of the rolled copper foil. Therefore, softening of the copper foil during manufacture of the negative electrode for lithium ion secondary battery, due to the long time heat treatment at a high temperature, can be prevented. Further, Cr in a solid-soluted state (also called solid-soluted Cr hereafter) is separated in the parent phase of Cu as a single substance by the heat treatment. Cr in a separated state (also called separated Cr hereafter) exhibits an action of improving the mechanical strength and the conductivity of the rolled copper foil.

According to the inventors of the present invention, in the manufacturing steps of the negative electrode for lithium ion secondary battery, in order to cause an age hardening of hardening the rolled copper foil by separating Cr by the heat treatment at a high temperature as described above, it is important that a solid-soluted Cr content in the parent phase is maintained to be high in a state of the rolled copper foil before the heat treatment. Namely, there is a necessity for appropriately controlling the solid-soluted Cr content in the parent phase.

Meanwhile, due to such a control, difficulty is involved in accurately grasping the solid-soluted Cr content. It is not easy to directly and accurately measure the solid-soluted Cr content in the parent phase in a crystal structure in which Cr is separated and finely dispersed by the heat treatment. Further, an accurate measurement cannot be performed even if the solid-soluted Cr content is indirectly calculated by measuring the separated Cr content.

Therefore, it is found by the inventors of the present invention, that the solid-soluted Cr content in the rolled copper foil has a great influence on the conductivity of the rolled copper foil. However, in this case, an alloy composition is different every time the solid-soluted Cr content is different, and a value of the conductivity itself is changed. This point needs to be taken into consideration.

As a result of strenuous efforts, the inventors of the present invention obtain a knowledge that the solid-soluted Cr content can be accurately grasped and can be controlled as an index of the conductivity, in consideration of a variation of the conductivity, which is the variation accompanied by the variation of the alloy composition.

The present invention is based on the aforementioned knowledge obtained by the inventors of the present invention.

### An Embodiment of the Present Invention

### (1) A Schematic Structure of the Lithium Ion Secondary Battery

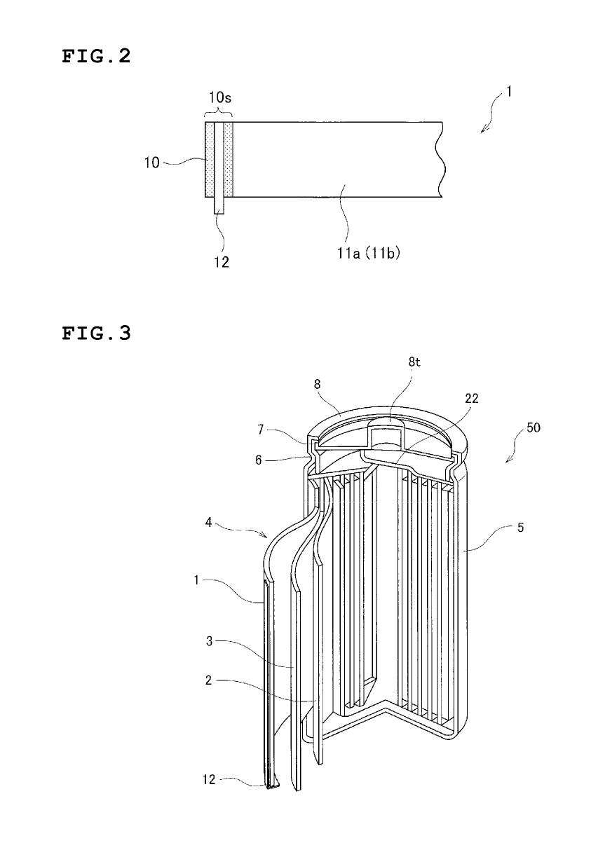

First, a schematic structure of the lithium ion secondary battery according to an embodiment of the present invention will be descried, with reference to FIG. 2 and FIG. 3. FIG. 2 is a plane view of a negative electrode for lithium ion secondary battery 1 according to this embodiment. FIG. 3 is a perspective cross-sectional view of a lithium ion secondary battery 50 according to this embodiment.

As shown in FIG. 3, the lithium ion secondary battery 50 includes a battery outer casing 5 being a container in which electrolyte not shown is enclosed. The negative electrode for lithium ion secondary battery (simply called “negative electrode 1” hereafter) having a tab lead 12, and a lithium ion secondary battery positive electrode 2 (simply called “positive electrode 2” hereafter) having a tab lead 22, are housed in the battery outer casing 5, with a separator 3 interposed between them.

Further, as shown in FIG. 2, the negative electrode 1 includes a current collector copper foil of negative electrode for lithium ion secondary battery 10 (simply called “negative electrode current collector copper foil 10” hereafter), and negative electrode active material layers 11a, 11b formed on both side of the current collector copper foil of negative electrode for lithium ion secondary battery 10. The aforementioned tab lead 12 is directly connected to an exposed region 10s of the negative electrode current collector copper foil 10. Detailed structures of the lithium ion secondary battery 50 and the negative electrode for lithium ion secondary battery 1 will be described later.

### (2) A Structure of the Current Collector Copper Foil of Negative Electrode for Lithium Ion Secondary Battery

The current collector copper foil of negative electrode for lithium ion secondary battery 10 according to an embodiment of the present invention will be described hereafter.

### (A Structure of the Negative Electrode Current Collector Copper Foil)

The negative electrode current collector copper foil 10 is formed, containing at least 0.15 wt % or more, or 0.40 wt % or less of chromium (Cr), and preferably 0.20 wt % or more and 0.40 wt % or less of Cr, and containing Cu as a remaining portion as a Cu—Cr alloy rolled copper foil, with a thickness of 20 μm or less.

Further, an alloy element for improving the mechanical strength and the heat resistant property may also be added to the negative electrode current collector copper foil 10. As such elements, for example silver (Ag), tin (Sn), indium (In), titanium (Ti), zirconium (Zr), etc., can be given. The negative electrode current collector copper foil may contain 0.01 wt % or more and 0.40 wt % or less of the aforementioned one kind or more elements in total.

As described above, the heat resistant property is improved by solid-soluting Cr in the parent phase. Further, the solid-soluted Cr is separated in the parent phase by the heat treatment, thereby improving the mechanical strength and the conductivity. As described above, by containing 15 wt % or more of Cr, the solid-soluted Cr can be further surely separated. Moreover, by setting the content of Cr to 0.40 wt % or less, undissolved Cr is prevented from forming a coarse grain second phase separated material during a solid solution treatment as will be describe later. Therefore, the following case can be prevented: improvement of the mechanical strength of the negative electrode current collector copper foil 10 is inhibited due to precipitation of the solid-soluted Cr and processability is reduced, by preventing a fine dispersion of the separated Cr. Note that by defining Cr based on the following formulas (1) to (3), the mechanical strength is further surely secured.

In addition, each of the aforementioned elements is further added to the negative electrode current collector copper foil 10 for example, content of which reaches 0.01 wt % or more in total, so that the mechanical strength and the heat resistant property can be improved. Thus, an effect of improving the mechanical strength and the heat resistant property can be sufficiently exhibited. Meanwhile, when the content of each of the aforementioned elements exceeds 0.40 wt % in total, the conductivity of the negative electrode current collector copper foil 10 is deteriorated. However, in this embodiment, as will be described later, the mechanical strength and the heat resistant property are secured by maintaining the solid-soluted Cr content to a prescribed content or more, and each of the aforementioned elements such as Ag, Sn, In, Ti, and Zr, etc., is auxiliarily used. Therefore, a total content of such elements can be set to 0.40 wt % or less. Accordingly, there is no case that the conductivity of the negative electrode current collector copper foil 10 is decreased more than necessary. Therefore, increase of the internal resistance of the lithium ion secondary battery 50 manufactured using the negative electrode current collector copper foil 10, can be suppressed. Further, the deterioration of a performance, etc., of the lithium ion secondary battery including a discharge rate performance, can be suppressed.

### (Cr Solid Solution Index of the Negative Electrode Current Collector Copper Foil)

Further, in the negative electrode current collector copper foil 10, each kind of value is controlled so that the Cr solid solution index Z of the following formula (1) is expressed by 0.05≦Z≦0.3.

$$\begin{matrix}[ Formula 1 ] & \\ Z = \frac{( {R}_{M} - {R}_{S} )}{( {R}_{P} - {R}_{S} )} & ( 1 )\end{matrix}$$

Wherein in the formula (1),

conductivity R_{M} indicates actually measured conductivity R (% IACS) of the negative electrode current collector copper foil 10, and conductivity Rₛ indicates calculated conductivity R (% IACS) of the negative electrode current collector copper foil 10, which is the conductivity R (% IACS) defined by the following formula (3) from electric resistivity ρ obtained by substituting a content concentration [atomic %] of each alloy element in a solid-soluted state when a total content of Cr is solid-soluted, into the following formula (2), and conductivity Rₚ indicates calculated conductivity R (% IACS) of the negative electrode current collector copper foil 10, which is the conductivity R (% IACS) defined by the following formula (3) from the electric resistivity ρ obtained by substituting the content concentration [atomic %] (at %) of each alloy element in a solid-soluted state when a total content of Cr is separated, into the following formula (2).

Wherein, each conductivity R (% IACS) is the conductivity R of a prescribed substance, with conductivity R of International Annealed Copper Standard set as 100%, wherein electric resistivity is 1.724×10⁻² μΩ·m.

$$\begin{matrix} [ Formula 2 ] & \\ ρ = 17.241 + ( 40 \times Cr concentration [ at \% ] + 1.2 \times Ag concentration [ at \% ] + 28.8 \times Sn concentration [ at \% ] + 10.5 \times In concentration [ at \% ] + 116.1 \times Ti concentration [ at \% ] + 110 \times Zr concentration [ at \% ] ) - ( 3.2 \times 28.8 \times Sn {concentration [ at \% ]}^{2} + 2.4 \times 10.5 \times In {concentration [ at \% ]}^{2} + 116.1 \times Ti {concentration [ at \% ]}^{2} ) / 100 & ( 2 ) \\ [ Formula 3 ] & \\ R = ( \frac{17.241}{ρ} ) \times 100 & ( 3 )\end{matrix}$$

When calculating the conductivity Rₛ for example using the above-descried formula (2), a value to be substituted into the Cr concentration [at %] of the above-described formula (2) is obtained by converting a total content of Cr in a solid-soluted state to a concentration (atomic %) wherein the total content of Cr is contained in the negative electrode current collector copper foil 10.

Further, when the conductivity Rₚ is calculated, a value substituted into the Cr concentration [at %] of the above-described formula (2) is Cr in a solid-soluted state when all Cr are separated, namely is zero.

Further, the other arbitrary alloy elements E described above are all in the solid solution state basically, irrespective of a state of Cr. Therefore, in either case of the conductivity Rₛ or the conductivity Rp of the formula (2), a value substituted into the E concentration [at o] is a value obtained by converting a total content of E to a concentration (atomic %), wherein the total content of E is contained in the negative electrode current collector copper foil 10. Note that in a case that the alloy elements excluding Cr are not contained in the negative electrode current collector copper foil 10, zero is substituted into the E concentration.

As described above, various difficulties are involved in accurately grasping and controlling the actual solid-soluted Cr content. Regarding the rolled copper foil containing at least Cr, or Ag, Sn, In, Ti, and Zr, etc., the inventors of the present invention acquires measurement data regarding the mechanical strength and the conductivity, etc., under various contents of the alloy elements and manufacturing conditions, and perform analysis.

In Formula (2), based on the measurement data, Linde-Nordheim law is applied to a second-order term of each alloy element E using Taylor expansion. Each coefficient in a parenthesis of a first-order term in the formula indicates a contribution ratio [symbol] ρ to electric resistance ρ per unit concentration of each element E contained in the negative electrode current collector copper foil 10. Further, each coefficient in the parenthesis of a second-order term indicates a corrected term ν for each element E respectively. The value of each coefficient is based on the following technical document (I).
(I) Table 2 of pp. 4 in Copper and copper alloy (4)1 (2002) of “Resistivity of Copper Alloys, its Interpretation and Application” by Shinya Komatsu

With a structure described above, the negative electrode current collector copper foil 10 having a sufficient mechanical strength can be obtained even if the heat treatment is applied thereto in the manufacturing steps of the negative electrode for lithium ion secondary battery 1. More specifically, the mechanical strength of the negative electrode current collector copper foil 10 is defined as follows.

Namely, in the manufacturing steps of the negative electrode for lithium ion secondary battery 1, the negative electrode current collector copper foil 10 has a reduction of a tensile force in a rolling direction of the negative electrode current collector copper foil 10 is within a range of 30N/mm² or less after applying heat treatment to the negative electrode current collector copper foil 10 at 350° C. or more and 500° C. or less, for 1 hour or more and 15 hours or less. Further at this time, preferably the mechanical strength can be secured so that the tensile force in the rolling direction is 400 N/mm² or more.

Further, owing to the aforementioned structure, the negative electrode current collector copper foil 10 having a high conductivity can be obtained. Namely, the negative electrode current collector copper foil 10 is configured to have the conductivity of preferably 70% IACS or more after a similar heat treatment as described above is applied thereto.

### (Evaluation Based on Cr Solid Solution Index)

A meaning of the above-described formula (1) will be described hereafter further in detail.

As described above, in the negative electrode current collector copper foil 10 of this embodiment, the solid-soluted Cr content is evaluated and controlled based on the Cr solid solution index Z using the conductivity, to thereby maintain a high solid-soluted Cr content which is effective for causing the age hardening. In the evaluation of the solid-soluted Cr content, the following point is required to be focused. Namely, in a case of a different solid-soluted Cr content, the alloy composition in the rolled copper foil is also varied, thus varying a conductivity value itself. In the above-described formula (1), an influence of the variation in the conductivity, which is caused by such a variation of the alloy composition, is also taken into consideration.

More specifically, in a case that the total content of Cr contained in the negative electrode current collector copper foil 10 is solid-soluted in the parent phase, the conductivity R is set in a minimum state, because it is easily influenced by the Cr content. Therefore the conductivity Rₛ is in the minimum state. Further, in a case that the total content of Cr contained in the negative electrode current collector copper foil is separated in the parent phase of Cu, the conductivity R becomes maximum. Therefore the conductivity Rₚ is in the maximum state.

Namely, a denominator of the formula (1) corresponds to a maximum variation width of the conductivity R, which is regarded as a variation range of the solid-soluted Cr content. Further, a numerator of the formula (1) is a value in which a quantity of an actual solid-soluted Cr content in the negative electrode current collector copper foil 10 is reflected. Namely, the Cr solid solution index Z expressed by the formula (1) is an index showing a degree of an actual solid-soluted Cr content in the parent phase, on a scale showing the variation range of the solid-soluted Cr content.

Thus, the quantity of the solid-soluted Cr content in the parent phase can be evaluated by the Cr solid solution index Z. Namely, the solid-soluted Cr content is increased as the Cr solution index Z is smaller, and the solid-soluted Cr content is decreased as the Cr solid solution index Z is larger.

In this embodiment, the Cr solid solution index Z is set to 0.3 or less, and therefore a sufficient content of solid-soluted Cr is secured in the negative electrode current collector copper foil 10. Further, since the Cr solid solution index Z is 0.05 or more, the following case is excluded, the case that a sufficient content of solid-soluted Cr is not contained due to other factors such that Cr absolute content (addition) is small in the negative electrode current collector copper foil 10. Thus, the age hardening utilizing the heat treatment in the manufacturing steps of the negative electrode for lithium ion secondary battery 1, is controlled. Namely, the softening due to the heat treatment at a high temperature for a long time can be suppressed and a sufficient mechanical strength of the negative electrode current collector copper foil 10 can be secured.

Note that in order to obtain a sufficient mechanical strength by the age hardening, there is a considerable influence of not only the solid-soluted Cr content and the separated Cr content, etc., but also a size and a dispersion state of the separated materials. The solid-soluted Cr content and the size and the dispersion state, etc., of the separated materials, will be described later.

### (3) A Method of Manufacturing a Current Collector Copper Foil of Negative Electrode for Lithium Ion Secondary Battery

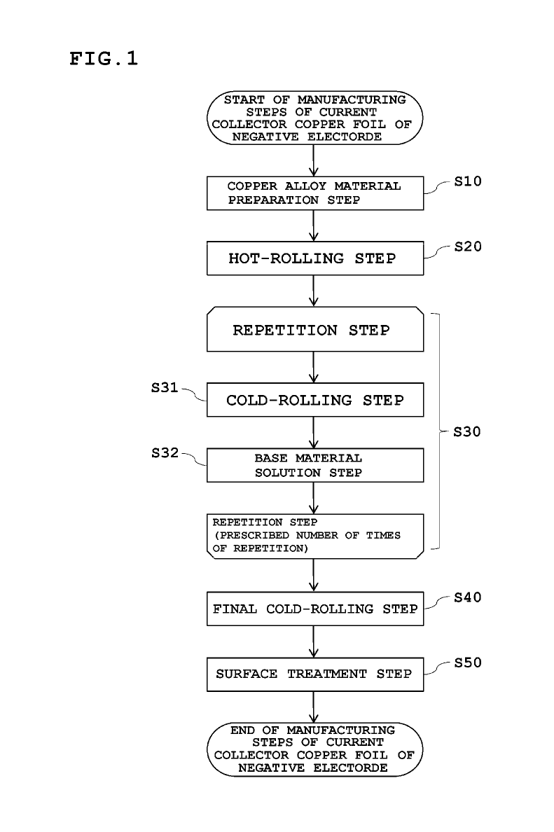

A method of manufacturing a current collector copper foil of negative electrode for lithium ion secondary battery will be described next, with reference to FIG. 1. FIG. 1 is a flowchart showing the manufacturing steps of the negative electrode current collector copper foil 10 according to this embodiment.

### (Copper Alloy Material Preparation Step S10)

As shown in FIG. 1, first, a raw material ingot being a copper alloy material, is prepared. Such an ingot is obtained by casting by dissolving Cr and Cu so that at least 0.15 wt % or more and 0.40 wt % or less of Cr is contained, and preferably 0.20 wt % or more and 0.40 wt % or less of Cr is contained. Oxygen-free copper (OFC) or tough-pitch copper, etc., can be used for example as Cu being a parent material. Further, one kind or more elements of Ag, Sn, In, Ti, and Zr may be contained as needed, by 0.01 wt % or more and 0.40 wt % or less in total.

### (Hot-Rolling Step S20)

A hot-rolling treatment is applied to the ingot, to thereby form a plate material. Note that heat treatment of homogenizing a segregation generated in a cast structure is preferably performed, prior to the hot-rolling step S20. Specifically, the ingot is held in a temperature range higher than a temperature for maintaining an equilibrium state and a homogeneous solid solution state. A heating temperature is preferably set to 800° C. or more and 950° C. or less.

### (Repetition Step S30)

Subsequently, a repetition step S30 is performed to the plate material that has undergone the hot-rolling step, in which a cold-rolling step S31 and a base material solution step S32 are repeated multiple numbers of times.

The cold-rolling step S31 is performed, with a degree of cold-rolling set to 50% or more for example. When a thickness of a processed object (the plate material made of copper) prior to the cold-rolling step S31 is defined as T_{B}, and a thickness of a processed object after the cold-rolling step S31 is defined as T_{A}, the processability is expressed by degree of cold-rolling (%)=[(T_{B}−T_{A})/T_{B}]×100.

In the base material dissolution step S32, by applying a solid solution treatment to the base material at a prescribed temperature, the solid-soluted Cr content is sufficiently secured in the base material. At this time, by applying the solid solution treatment to the base material at a temperature of 850° C. or more and 950° C. or less for example, the base material with the Cr solid solution index Z satisfying 0.05≦Z≦0.3 after cooling, can be obtained. However, an optimal temperature is slightly varied depending on the alloy composition. By setting the Cr solid solution index Z within a prescribed range, the separated Cr content is sufficiently generated to cause a separated reinforcement by the heat treatment in the manufacturing steps of the negative electrode for lithium ion secondary battery 1. Therefore, the negative electrode current collector copper foil 10 having a high heat-resistant property and a mechanical strength can be obtained.

Note that after an end of the base material solution step S32 which is a final stage of the repetition treatment, the temperature of the base material is maintained to less than 350° C. for example until an end of a final cold-rolling step S40 as will be described later, thereby not exposing the base material under a high temperature. Thus, the negative electrode current collector copper foil 10 is manufactured in a state of sufficiently holding the solid-soluted Cr content.

### (A Final Cold-Rolling Step S40)

A final cold-rolling step S40 is applied to the base material that has undergone the repetition step S30 and thereafter the solid solution treatment. Thus, the rolled copper foil having a prescribed thickness such as 20 μm or less is obtained. At this time, with a degree of solid-rolling set to 95% or more and 99% or less, a strain being a starting point of the separation of the solid-soluted Cr generated by the solid solution treatment, is preferably sufficiently introduced. Thus, by securing a sufficient strain, fine dispersion of the separated material of Cr occurs when the separated Cr is generated by the heat treatment which is performed in the manufacturing steps of the negative electrode for lithium ion secondary battery 1. Since the separated material of Cr is in a finely dispersed state, the effect of improving the mechanical strength and the conductivity can be further easily exhibited.

### (A Surface Treatment Step S50)

A prescribed surface treatment such as roughening treatment and a rustproof treatment is applied to the base material that has undergone the above-described steps, to thereby manufacture the current collector copper foil of negative electrode for lithium ion secondary battery 10.

### (4) A Method of Manufacturing a Negative Electrode for Lithium Ion Secondary Battery

A method of manufacturing a negative electrode for lithium ion secondary battery 1 having a structure shown in FIG. 2 will be described next.

### (Slurry Coating Step)

First, a method of applying and compression-bonding slurry onto the negative electrode current collector copper foil 10, will be described. Such a step is performed using an apparatus like an applicator for applying the slurry onto the negative electrode current collector copper foil 10 by a continuous line of a coil-to-coil system for example.

Specifically, the slurry in which the negative electrode active material, a binder solution, and a conductive assistant as needed are kneaded, is applied onto both sides of the negative electrode current collector copper foil 10, and compression-bonded thereto in approximately a uniform thickness, which is then dried for several minutes to several tens of minutes at 70° C. to 130° C.

As the negative electrode active material contained in the slurry, powder of an alloy of Sn, Si, etc., or a compound thereof can be used. A diameter of an individual powder is several μm to several tens of μm for example. Further, as the binder solution, a solution of precursors of imide resin such as polyimide (PI) and the other resin, can be used.

### (Heat Treatment Step)

Next, heat treatment is applied to the negative electrode current collector copper foil 10 to which the slurry is compression-bonded, using an infrared heating furnace, etc., for example, for a long time at a temperature higher than a temperature of a thermoplastic region of the binder component. More specifically, the heat treatment is applied to the negative electrode current collector copper foil 10 at 350° C. or more and 500° C. or less for 1 hour or more and 15 hours or less. Thus, for example, an imidizing reaction of the binder component composed of the precursor of the imide resin, etc., is advanced and solidified while the binder component enters into a roughened surface of a particle of the negative electrode active material. Thus, negative electrode active material layers 11a, 11b including the negative electrode active material and the imidized binder resin are formed on both sides of the negative electrode current collector copper foil 10, with a high binding performance.

Further, owing to this heat treatment, the solid-soluted Cr in the negative electrode current collector copper foil 10 is separated into the parent phase of Cu in a single substance state, to become the separated Cr. As described above, the negative electrode current collector copper foil 10 is controlled so that the Cr solid solution index Z is in a range of 0.05≦Z≦0.3, and a sufficient content of the separated Cr can be obtained. Thus, the separated reinforcement occurs. Therefore, the negative electrode current collector copper foil 10 having both the sufficient mechanical strength and conductivity can be obtained while suppressing the softening by the long time heat treatment at a high temperature. Moreover, the negative electrode current collector copper foil 10 is subjected to the final cold-rolling step S40, with a degree of cold-rolling set to 95% or more and 99% or less, wherein the separated Cr is finely dispersed. Therefore, the effect of improving the mechanical strength and the conductivity can be further enhanced.

Thus, the negative electrode current collector copper foil 10 having a sufficient mechanical strength and conductivity can be obtained by the age hardening utilizing the heat treatment in the manufacturing steps of the negative electrode for lithium ion secondary battery 1. Therefore, the volume variation of the negative electrode current collector copper foil 10 in a process of discharging and charging cycle can be suppressed, and the high binding performance of binding with the negative electrode active material layers 11a, 11b can be secured.

### (A Tab Lead Connecting Step)

A method of connecting the tab lead 12 to the negative electrode current collector copper foil 10 will be described next, with reference to FIG. 2.

As shown in FIG. 2, the negative electrode current collector copper foil 10 with the negative electrode active material layers 11a, 11b formed on both sides, has an exposure region 10s in which the negative electrode active material layers 11a, 11b are not formed, on one end of at least one side or both sides thereof. The tab lead 12 is connected to the exposure region 10s of the negative electrode current collector copper foil 10 by welding for example. Thus, electric connection to the battery outer casing 5 of the lithium ion secondary battery 50 is obtained.

Namely, the exposure region 10s of the negative electrode current collector copper foil 10 and the tab lead 12 composed of Ni or Ni-plated copper for example, are overlapped on each other. Then, a welding treatment is performed using an ultrasonic welder for example, in a prescribed loading time while adding a prescribed welding force and load energy. Thus, the negative electrode current collector copper foil 10 and the tab lead 12 are connected to each other.

As described above, the negative electrode for lithium ion secondary battery 1 is manufactured, including the current collector copper foil of negative electrode for lithium ion secondary battery 10, the negative electrode active material layers 11a, 11b formed on both sides of the negative electrode current collector copper foil 10, and the tab lead 12 connected to the negative electrode current collector copper foil 10.

### (5) A Method of Manufacturing a Lithium Ion Secondary Battery

A method of manufacturing a lithium ion secondary battery 50 will be described next, with reference to FIG. 3. Here, a cylindrical lithium ion secondary battery 50 shown in FIG. 3 is used as an example for explanation. However, a lithium ion secondary battery having other form such as a rectangular or a laminate type may also be used.

First, the negative electrode for lithium ion secondary battery 1 and the lithium ion secondary battery positive electrode 2 are laminated on each other with the separator 3 interposed between them, to thereby manufacture a wound body 4 in which such a lamination is wound around a winding core not shown. The positive electrode 2 includes a lithium ion secondary battery positive electrode current collector metal foil; positive electrode active material layers formed on both sides of the positive electrode current collector metal foil (both of them are not shown), and a tab lead 22 connected to the positive electrode current collector metal foil. The metal constituting the positive electrode current collector metal foil is aluminum (Al) and the other metal, etc., for example. The positive electrode active material layers are made of a metaloxide composite containing Li for example. The separator 3 is made of a porous resin, etc., for example.

Next, a lower insulating plate not shown and the wound body 4 are housed in this order, in the battery outer casing 5 being a container. Subsequently, a mandrel (core metal) not shown is inserted into the wound body 4 and an upper insulating plate is housed in the battery outer casing 5, and thereafter a groove 6 is formed on the battery outer casing 5 (grooving). Thereafter, water content in the battery outer casing is reduced by drying. When inside of the battery outer casing 5 is sufficiently dried, an electrolyte not shown is injected. A gasket 7 is attached in the vicinity of the groove 6 of the battery outer casing 5. Then, the tab lead 12 of the negative electrode 1 is welded to the battery outer casing 5, and the tab lead 22 of the positive electrode 2 is welded to a terminal 8t of a cap 8 respectively, and the cap 8 is crimped (compression-bonded) to the battery outer casing 5, to enclose the electrolyte.

As described above, there is provided the lithium ion secondary battery 50 including the battery outer casing 5 in which the negative electrode for lithium ion secondary battery 1 and the lithium ion secondary battery positive electrode 2 are housed, with the separator 3 interposed between them, and an electrolyte is enclosed therein.

### Other Embodiment of the Present Invention

As described above, an embodiment of the present invention has been specifically described. However, the present invention is not limited thereto, and can be variously modified within a range not departing from the gist of the invention.

For example, in the above-described embodiment, in order to maintain the conductivity to a prescribed value or more, the content of the alloy elements of Ag, Sn, In, Ti, and Zr, etc., is suppressed to a prescribed quantity or less. However, irrespective of such a matter, the technique of the present invention can be used, namely the technique of setting Cr to a prescribed content and maintaining the mechanical strength after the heat treatment based on the definition of the formula (1) to formula (3), can be used. Specifically, an object of the present invention can be achieved even in a case that the total content of the aforementioned elements is a prescribed value or more and the conductivity is slightly deteriorated. Namely, the object of the present invention such as securing the mechanical strength can be achieved.

Further, according to the above-described embodiment, the degree of cold-rolling in the final cold-rolling step S40 is set to 95% or more, to thereby further improve the mechanical strength. However, even if the degree of cold-rolling is less than 95%, a prescribed effect can be obtained by the technique of the present invention.

Further, according to the above-described embodiment, the negative electrode active material layers 11a, 11b are formed on both sides of the negative electrode current collector copper foil 10. However, the negative electrode active material layers may be formed on at least one side of the negative electrode current collector copper foil.

### Examples

Evaluation results of the mechanical strength and the conductivity of the lithium ion secondary current collector copper foil according to examples of the present invention will be described hereafter.

### (1) Manufacture of the Negative Electrode Current Collector Copper Foil

First, negative electrode current collector copper foils according to examples 1 to 21 and comparative examples 1 to 5 were manufactured based on a procedure as will be described hereafter.

As the negative electrode current collector copper foils used for the evaluation, the negative electrode current collector copper foils with oxygen-free copper as a parent material, containing at least prescribed content of Cr, or containing prescribed content of one kind or more alloy elements of Ag, Sn, In, Ti, and Zr, were manufactured by a similar procedure and technique as the above-described embodiment, in examples 1 to 21, and comparative examples 1 to 5. However, one or a plurality of conditions deviated from the aforementioned structure are included in comparative examples 1 to 5. Further, in comparative examples 4 and 5, after a similar repetition step as the aforementioned embodiment, heat treatment at 400° C. to 500° C. was performed as an aging treatment, before the final cold-rolling step.

Test pieces having a width of 15 mm and a length of 200 mm were cut out in a rolling direction, from the negative electrode current collector copper foils according to examples 1 to 21 and comparative examples 1 to 5, and the heat treatment at a prescribed temperature was applied thereto for a prescribed time so as to imitate the heat treatment in the manufacturing steps of the negative electrode for lithium ion secondary battery. Namely, in comparative examples 4 and 5, the heat treatment was performed twice before and after the final cold-rolling step.

Further, an electric resistance of each test piece was measured by a four-terminal measuring method before and after the heat treatment imitating the heat treatment in the manufacturing steps of the negative electrode for lithium ion secondary battery. Moreover, based on a measurement result, the Cr solid solution index Z was obtained in examples 1 to 21, and comparative examples 1 to 5.

Further, a tensile test was performed to each test piece before and after the heat treatment imitating the heat treatment in the manufacturing steps of the negative electrode for lithium ion secondary battery, to thereby evaluate a (mechanical) strength. The tensile test was based on American Society for Testing and Materials (ASTM) E-345, and a tensile strength in parallel to the rolling direction was measured.

### (2) Evaluation Results of the Negative Electrode Current Collector Copper Foil

Results of the aforementioned evaluation are shown in table 1 as follows.

TABLE 1

| | | | | | | | | | Before heat treatment | | | | |
|---|---|---|---|---|---|---|---|---|---|---|---|---|---|
| | | | | | | | | | Degree of | | Cr solid- | Strength | |
| | | Alloy composition (wt %) | | | | | | | cold-rolling | Conductivity | solution | ( [symbol] | |
| | | Cu | Cr | Ag | Sn | In | Ti | Zr | (%) | R_{M (% IACS)} | index Z | N/mm²⁾ | Notes |
| Example | 1 | 99.60 | 0.40 | | | | | | 95 | 60.1 | 0.25 | 450 | |
| | 2 | 99.55 | 0.25 | 0.20 | | | | | 98 | 65.1 | 0.17 | 424 | |
| | 3 | 99.50 | 0.20 | | 0.30 | | | | 98 | 60.6 | 0.25 | 462 | |
| | 4 | 99.50 | 0.30 | | | 0.20 | | | 95 | 60.3 | 0.20 | 418 | |
| | 5 | 99.62 | 0.35 | | | | 0.03 | | 96 | 49.8 | 0.16 | 432 | |
| | 6 | 99.55 | 0.40 | | | | | 0.05 | 98 | 52.1 | 0.24 | 462 | |
| | 7 | 99.55 | 0.25 | 0.05 | 0.15 | | | | 95 | 59.2 | 0.15 | 447 | |
| | 8 | 99.40 | 0.20 | 0.20 | | 0.20 | | | 97 | 65.0 | 0.13 | 427 | |
| | 9 | 99.40 | 0.30 | | 0.10 | 0.20 | | | 95 | 54.0 | 0.11 | 421 | |
| | 10 | 99.48 | 0.35 | 0.15 | | | 0.02 | | 98 | 49.2 | 0.08 | 433 | |
| | 11 | 99.48 | 0.40 | | 0.10 | | 0.02 | | 99 | 51.6 | 0.27 | 466 | |
| | 12 | 99.50 | 0.25 | 0.05 | 0.10 | 0.10 | | | 98 | 61.3 | 0.20 | 452 | |
| | 13 | 99.70 | 0.20 | 0.05 | | | | 0.05 | 95 | 59.9 | 0.16 | 423 | |
| | 14 | 99.55 | 0.30 | | 0.10 | | | 0.05 | 99 | 52.3 | 0.20 | 428 | |
| | 15 | 99.50 | 0.35 | | | 0.10 | | 0.05 | 90 | 50.2 | 0.16 | 389 | |
| | 16 | 99.62 | 0.25 | | | 0.10 | 0.03 | | 92 | 57.2 | 0.27 | 392 | |
| | 17 | 99.15 | 0.25 | | 0.60 | | | | 95 | 50.8 | 0.30 | 456 | |
| | 18 | 99.10 | 0.30 | 0.30 | | | 0.30 | | 96 | 23.8 | 0.29 | 423 | |
| | 19 | 99.20 | 0.20 | | | 0.50 | 0.10 | | 97 | 41.0 | 0.28 | 413 | |
| | 20 | 99.00 | 0.40 | | 0.40 | | | 0.20 | 98 | 33.8 | 0.28 | 485 | |
| | 21 | 99.71 | 0.15 | 0.10 | | | | 0.04 | 97 | 68.2 | 0.27 | 399 | |
| Com. Ex. | 1 | 99.85 | 0.15 | | | | | | 95 | 71.0 | 0.03 | 417 | |
| | 2 | 99.50 | 0.50 | | | | | | 97 | 59.6 | 0.31 | 443 | |
| | 3 | 99.25 | 0.50 | | 0.20 | | | 0.05 | 96 | 51.4 | 0.44 | 423 | |
| | 4 | 99.70 | 0.30 | | | | | | 95 | 82.0 | 0.61 | 415 | * |
| | 5 | 99 45 | 0.25 | 0.10 | 0.20 | | | | 96 | 79.2 | 0.83 | 438 | |

| | | After heat treatment | | | | |
|---|---|---|---|---|---|---|
| | | | | | Strength | |
| | | | | Conductivity R_{M} | (N/ | Strength reduction |
| | | Heat treatment temperature (° C.) | Heat treatment time (h.) | (% IACS) | mm²⁾ | ( [symbol] N/mm²⁾ |
| Example | 1 | 400 | 2 | 84.2 | 432 | 18 |
| | 2 | 350 | 15 | 82.1 | 416 | 8 |
| | 3 | 400 | 5 | 76.9 | 445 | 17 |
| | 4 | 350 | 10 | 81.4 | 424 | No |
| | | | | | | reduction |
| | 5 | 400 | 15 | 75.2 | 421 | 11 |
| | 6 | 450 | 10 | 78.2 | 446 | 16 |
| | 7 | 400 | 10 | 80.5 | 452 | No |
| | | | | | | reduction |
| | 8 | 450 | 2 | 81.3 | 425 | 2 |
| | 9 | 400 | 5 | 80.0 | 411 | 10 |
| | 10 | 450 | 15 | 79.9 | 447 | No |
| | | | | | | reduction |
| | 11 | 450 | 10 | 74.0 | 452 | 14 |
| | 12 | 400 | 15 | 71.7 | 444 | 8 |
| | 13 | 500 | 5 | 75.6 | 413 | 10 |
| | 14 | 450 | 15 | 71.4 | 423 | 5 |
| | 15 | 500 | 10 | 75.2 | 372 | 17 |
| | 16 | 400 | 10 | 81.3 | 390 | 2 |
| | 17 | 350 | 10 | 62.9 | 448 | 8 |
| | 18 | 400 | 10 | 27.5 | 430 | No |
| | | | | | | reduction |
| | 19 | 400 | 15 | 46.3 | 412 | 1 |
| | 20 | 450 | 10 | 52.3 | 488 | No |
| | | | | | | reduction |
| | 21 | 350 | 15 | 83.7 | 394 | |
| Com. Ex. | 1 | 400 | 10 | 85.3 | 296 | 121 |
| | 2 | 450 | 5 | 83.7 | 382 | 61 |
| | 3 | 400 | 10 | 79.3 | 390 | 33 |
| | 4 | 350 | 15 | 74.9 | 208 | 207 |
| | 5 | 300 | 20 | 70.5 | 315 | 123 |

Com. Ex. = Comparative Example
* = heat treatment after solid-solution of base material

As shown in table 1, the negative electrode current collector copper foil is formed in example 1, containing Cr only. Further, the content of Cr, the Cr solid solution index Z, and each kind of condition in the manufacturing step of the negative electrode current collector copper foil, such as a degree of cold-rolling in the final cold-rolling step, are set within prescribed values. Therefore, reduction of the tensile strength after heat treatment imitating the heat treatment in the manufacturing steps of the negative electrode for lithium ion secondary battery, namely reduction in strength, was 30N/mm² or less compared with a strength before the heat treatment. Moreover, a numerical value itself of the tensile strength was 400N/mm², and a considerably excellent result could be obtained. Further, the conductivity was 70% IACS or more, and a high value could be obtained.

Further, in examples 2 to 14, each kind of alloy element within a prescribed content was contained, in addition to Cr within a prescribed content. Moreover, each kind of condition in the manufacturing step of the negative electrode current collector copper foils is set within a prescribed value. Therefore, in examples 2 to 14 as well, the reduction of the tensile strength before and after the heat treatment was 30N/mm² or less, and the tensile strength was 400N/mm² or more, and the conductivity was 70% IACS or more. Thus, an excellent result was obtained.

Accordingly, it was found that in a case of the negative electrode current collector copper foils satisfying the aforementioned each kind of condition, higher values could be obtained in both the mechanical strength and the conductivity even after the heat treatment.

Further, in examples 15 and 16, the degree of cold-rolling in the final cold-rolling step was less than 95% in both examples. In this case, although the tensile stress itself was less than 400N/mm² and is relatively lower, the reduction of the tensile strength before and after the heat treatment was 30N/mm² or less. Therefore, a prescribed object of securing the mechanical strength was achieved even after the heat treatment.

Further, in examples 17 to 20, the total content of the elements such as Ag, Sn, In, Ti, and Zr exceeds 0.40 wt %. Therefore, although the conductivity was less than 70% IACS and was relatively lower, the reduction of the tensile strength before and after the heat treatment was 30N/mm² or less. Therefore, the prescribed object of securing the mechanical strength even after the heat treatment, was achieved.

Further, in example 21 as well in which the content of Cr was a lower limit value and the Cr solution index Z was closed to an upper limit value, the tensile strength itself was less than 400N/mm² and was relatively lower. However, the reduction of the tensile strength before and after the heat treatment was 30N/mm² or less, and the prescribed object of securing the mechanical strength even after the heat treatment, was achieved.

Thus, it is found that even if several items such as the degree of cold-rolling in the final cold-rolling step or the content of each kind of elements, are deviated from the aforementioned conditions, the mechanical strength after the heat treatment can be secured, provided that the content of Cr and the Cr solid solution index Z are within prescribed values.

Meanwhile, according to comparative example 1, the Cr solid solution index Z was less than a lower limit value, then the tensile strength was insufficient, and the reduction of the tensile strength exceeded 30N/mm².

Further, according to examples 2 and 3, there was an excessive content of Cr, and therefore the fine dispersion of the separated materials was inhibited, then the tensile strength was insufficient, and the reduction of the tensile strength exceeded 30N/mm².

Further, according to comparative examples 4 and 5, the aging treatment was performed before the final cold-rolling step, and therefore the Cr solid solution index Z exceeded 0.3. As a result, softening occurs by a regular heat treatment, resulting in an insufficient tensile strength. Further, in comparative examples 4 and 5, the reduction of the tensile strength exceeded 30N/mm² in both cases.

What is claimed is:

1. A current collector copper foil of negative electrode for lithium ion secondary battery, comprising:
at least 0.15 wt % or more and 0.40 wt % or less of Cr; and
Cu as a remaining portion,
wherein a Cr solid solution index Z is in a range of 0.05≦Z≦0.3 and represented by the following formula (1),
$$\begin{matrix}[ Formula 1 ] & \\ Z = \frac{( {R}_{M} - {R}_{S} )}{( {R}_{P} - {R}_{S} )} & ( 1 )\end{matrix}$$
wherein in the formula (1), conductivity R_{M} indicates an actually measured conductivity R (% IACS) of the current collector copper foil of negative electrode for lithium ion secondary battery, and conductivity R_{S} indicates a calculated conductivity R (% IACS) of the current collector copper foil of negative electrode for lithium ion secondary battery, which is the conductivity R (% IACS) defined by the following formula (3) from electric resistivity ρ obtained by substituting a content concentration [atomic %] of each alloy element in a solid-soluted state when a total content of the Cr is solid-soluted, into the following formula (2), and conductivity R_{P} indicates a calculated conductivity R (% IACS) of the lithium ion secondary negative electrode current collector copper foil, which is the conductivity R (% IACS) defined by the following formula (3) from electric resistivity ρ obtained by substituting a content concentration [atomic %] (at %) of each alloy element in a solid-soluted state when a total content of the Cr is separated, into the following formula (2),
$$\begin{matrix} [ Formula 2 ] & \\ ρ = 17.241 + ( 40 \times Cr concentration [ at \% ] + 1.2 \times Ag concentration [ at \% ] + 28.8 \times Sn concentration [ at \% ] + 10.5 \times In concentration [ at \% ] + 116.1 \times Ti concentration [ at \% ] + 110 \times Zr concentration [ at \% ] ) - ( 3.2 \times 28.8 \times Sn {concentration [ at \% ]}^{2} + 2.4 \times 10.5 \times In {concentration [ at \% ]}^{2} + 116.1 \times Ti {concentration [ at \% ]}^{2} ) / 100 & ( 2 ) \\ [ Formula 3 ] & \\ R = ( \frac{17.241}{ρ} ) \times 100 & ( 3 )\end{matrix}$$

2. The current collector copper foil of negative electrode for lithium ion secondary battery according to claim 1, containing 0.01 wt % or more and 0.40 wt % or less of one kind or more elements in total, selected from a group consisting of Ag, Sn, In, Ti, and Zr.

3. The current collector copper foil of negative electrode for lithium ion secondary battery according to claim 1, having a thickness of 20 μm or less.

4. A method of manufacturing a current collector copper foil of negative electrode for lithium ion secondary battery, comprising:
applying hot-rolling to a copper alloy material containing at least 0.15 wt % or more and 0.40 wt % or less of Cr to form a plate material;
applying cold-rolling to the plate material to form a base material;
applying solid solution treatment to the base material, with a temperature of the base material maintained to 850° C. or more and 950° C. or less; and
applying final cold-rolling to the base material that has undergone the solid solution treatment.

5. The method of manufacturing a current collector copper foil of negative electrode for lithium ion secondary battery according to claim 4, wherein the copper alloy material contains 0.01 wt % or more and 0.40 wt % or less of one kind or more elements in total, selected from a group consisting of Ag, Sn, In, Ti, and Zr.

6. The method of manufacturing a current collector copper foil of negative electrode for lithium ion secondary battery according to claim 4, wherein in applying the final cold-rolling, cold-rolling is applied to the base material so that a degree of cold-rolling is 95% or more and 99% or less, and a thickness of the base material is set to 20 μm or less.

7. The method of manufacturing a current collector copper foil of negative electrode for lithium ion secondary battery according to claim 4, wherein after an end of applying the base material solid solution treatment, the temperature of the base material is maintained to less than 350° C. until application of the final cold-rolling is ended.

8. A negative electrode for lithium ion secondary battery, comprising:
the current collector copper foil of negative electrode for lithium ion secondary battery of claim 1;
a negative battery active material layer formed at least one side of the current collector copper foil of negative electrode for lithium ion secondary battery; and
a tab lead connected to the lithium ion secondary negative electrode current collector copper foil.

9. A method of manufacturing a negative electrode for lithium ion secondary battery, comprising:
coating at least one side of a current collector copper foil of negative electrode for lithium ion secondary battery manufactured by the method of claim 4, with slurry in which a negative battery active material and a binder solution are kneaded;
applying heat treatment to the current collector copper foil of negative electrode for lithium ion secondary battery which is coated with the slurry, to solidify a binder component in the slurry, and forming a negative battery active material layer on at least one side of the lithium ion secondary negative electrode current collector copper foil; and
connecting a tab lead to the lithium ion secondary negative electrode current collector copper foil,
wherein in applying the heat treatment, heat treatment is applied for 1 hour or more and 15 hours or less, with a temperature set to 350° C. or more and 500° C. or less.

10. A lithium ion secondary battery, comprising:
the negative electrode for lithium ion secondary battery of claim 8;
a lithium ion secondary battery positive electrode;
a separator inserted between the negative electrode for lithium ion secondary battery and the lithium ion secondary battery positive electrode; and
a container in which the negative electrode for lithium ion secondary battery and the lithium ion secondary battery positive electrode are housed, with the separator inserted between them, and an electrolyte is enclosed therein.
